(19) United States
(12) Patent Application Publication
(10) Pub. No.: US 2003/0200911 A1
(43) Pub. Date: Oct. 30, 2003

(54) Self-activating boat trailer backing guide

(76) Inventors: Lee Dudley Tatro, Leesburg, FL (US); Kenneth Dale Hollingsworth, Leesburg, FL (US)

Correspondence Address: Lee D. Tatro, 420 Brooks Lane, Leesburg, FL, 34748, US

(21) Appl. No.: 10/132,033

(22) Filed: Apr. 25, 2002

(51) Int. Cl. B60Q 11/00

(52) U.S. Cl. 116/28 R

(57) ABSTRACT

A very uncomplicated backing guide mountable to the rear most cross member of a boat or similar type trailer which would include a mounting bracket for mounting onto said cross member. There is also provided a fiberglass, composite rod engaged with a specially designed spring, attached by a pivot bolt to the apparatus, allowing the rod to be held in a horizontal position under the boat or material. When the boat or material is retrieved from the trailer and the trailer is empty, the guide would automatically position itself to a vertical position for viewing by the driver of the vehicle. The guide, while in a vertical position, would also serve as an alignment for a boat for centering while loading the boat onto the trailer.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

1. This invention relates to trailer backing guides for vehicles. This present invention relates to a guide to assist the driver of a vehicle in tracking the position of an attached, unloaded trailer when it is being backed. Specifically, a small trailer, like a personal watercraft trailer, which is extremely difficult to see when backing with out the personal watercraft loaded. The guide will automatically come to an upright, vertical position when the trailer is unloaded but will position itself horizontally under the boat when the boat is loaded on the trailer.

2. When a small watercraft trailer is being backed into the water to load said watercraft, it is difficult, if not impossible, to see the rear center portion of the trailer for directional purposes. Therefore, there is a need in the art for a guide which can be positioned or mounted at the center most location of the rear cross member of the trailer, which allows a rod to stand in a vertical position when the trailer is empty, but will remain in a horizontal position under the boat when said boat is loaded on the trailer.

3. The invention of aids for drivers of vehicles backing empty trailers has taken on various designs and configuration and is represented in prior art. By example, prior art discloses in U.S. Pat. No. 5,755,453 to Bell, a trailer guide with an elevated tube for viewing purposes, which manually must be raised and lowered during loading and unloading.

U.S. Pat. No., 6,062,160 to Delcambre, a trailer back up and boat reloading guide system. The configuration is one of a circle shaped short upright device, which is attached to the rear of the trailer with a counter weight and a reflective surface. There is a provided spring member engaged between the mounting post and bracket to maintain the vertical position high enough to be seen by the driver of the vehicle pulling the trailer. When the boat or material is loaded on the trailer, the art would remain in the horizontal position.

U.S. Pat. No. 6,199, 503 to Midgett is a boat trailer guide device that is mounted by bracket to the rear cross member of a trailer with a signal device of an elongated nature. It encompasses a floatation device lighter than water, and has a weight greater than the staff. When the trailer is out of the water, the staff is pivoted by the weight of the floatation element to a vertical position. When the rear of the trailer is backed into the water, the floatation element rises to pivot the staff to a horizontal position.

U.S. Pat. No. 5,596,944 by Massie, a boat trailer marking device, has an elongated arm and an extension arm and a signal, which may be a flag, light, or florescent paint strips on one end of the pivoted arrangement and a weight at the other. It is adapted to be mounted on the axle or frame of a boat trailer. This prior art appears to be complicated and can damage the lower hull of a boat.

In this respect, this trailer guide, with an elevated rod, controlled by an automatic spring device, for viewing purposes of backing an empty trailer, according to the present invention, substantially departs from the conventional concepts and designs of the prior art. Such a trailer may be used for boats, personal watercraft, snowmobiles, motorcycles or small utility trailers.

### BRIEF SUMMARY OF THE INVENTION

This present invention is directed to be a boat trailer guide that automatically assumes an upright vertical position when the boat trailer is empty and is automatically lowered to a horizontal position when the boat is loaded on the trailer.

The main objective of this present invention is to provide a guide for an empty trailer (example: personal water craft), so that the driver of the vehicle to which the trailer is attached, may have a point of reference for determining the central location of the rear of the trailer as it is being backed into a predetermined position (example: boat launching ramp). Also the driver of the boat will have a reference point for the center of the trailer when driving the boat from the water onto the boat trailer.

### BRIEF DESCRIPTION OF SEVERAL VIEWS OF THE DRAWING

For a better understanding of this invention, the following detailed drawings and descriptions in different perspectives will show how and why it functions as a better backing aid than the previous inventions.

FIG. 1 is an overall view of how the backing aid is attached to a trailer, especially small watercraft trailers.

FIG. 2 is a frontal illustration of the backing aid showing the “U” channel front bracket with the spring and elevated rod mounted on the trailer rear cross member. Also illustrated is the extra hole in the bracket for mounting on trailers with narrower cross members.

FIG. 3 is a side illustration of the backing aid showing how the bolts attach the front “U” channel bracket and the rear flat bar bracket to the trailer rear cross member.

FIG. 4 is a side cross section view to specifically show the spring function on the rod in the elevated position.

FIG. 5 is a side cross section view to show the rod going down, forward to the horizontal position when a boat is being loaded on to the trailer.

FIG. 6 summarizes how the backing apparatus functions during the loading process of a watercraft.

### DETAILED DESCRIPTION OF THE INVENTION

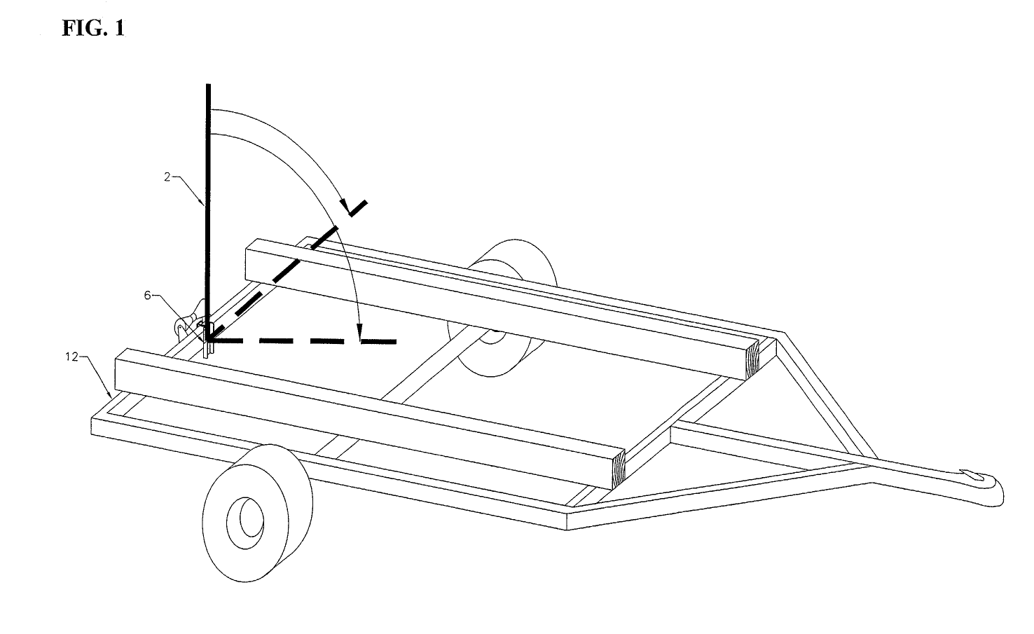

FIG. 1 illustrates the overall view of how the backing aid is attached to the trailer; the mounting point on the trailer 12 is the rear most cross member. The front “U” channel bracket 6 is attached so the elevated rod 2 will pivot forward on the trailer to a horizontal position when a boat is loaded on the trailer.

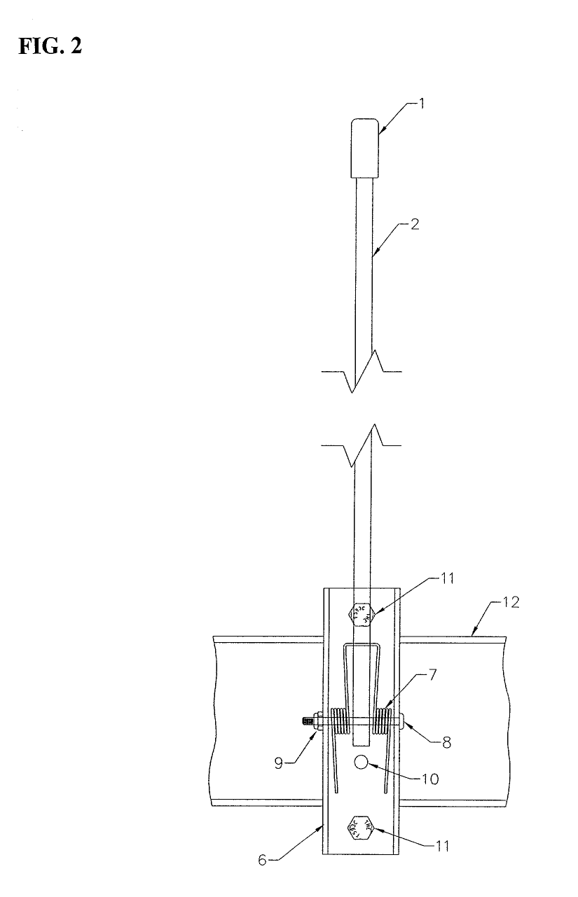

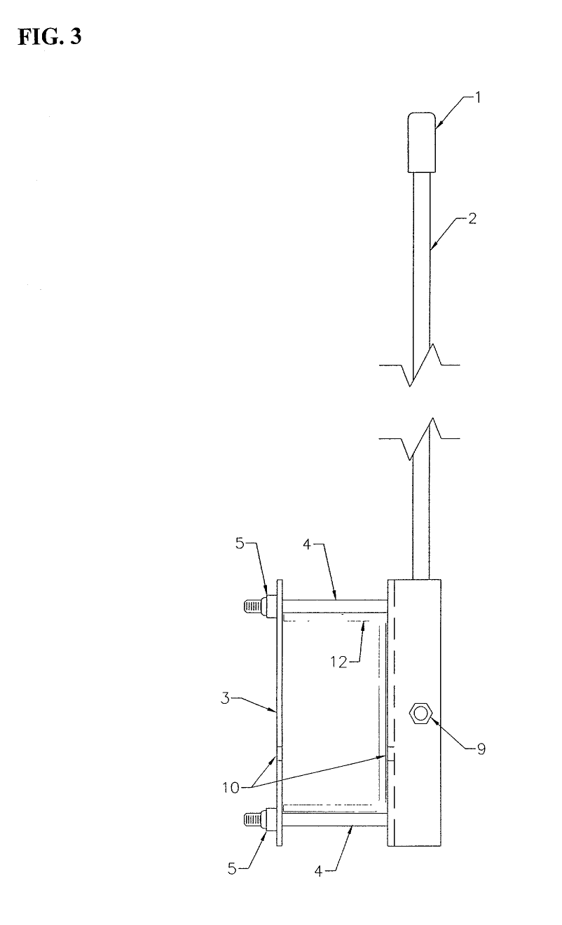

Turning now to more detailed illustrations, FIGS. 2-3 illustrates how the front “U” channel bracket 6 is attached to the trailer rear cross member 12 by two bolts 4, two self-locking nuts 5 and a rear flat bar bracket 3. The bolt heads 11 must be on the inside of the “U” channel bracket 6 so the bolt will not interfere with the elevating rod 2 from being able to come to a full vertical position. There is an extra hole 10 in both the front “U” channel 6 and the rear flat bar bracket 3 to accommodate trailers with narrower rear cross members 12.

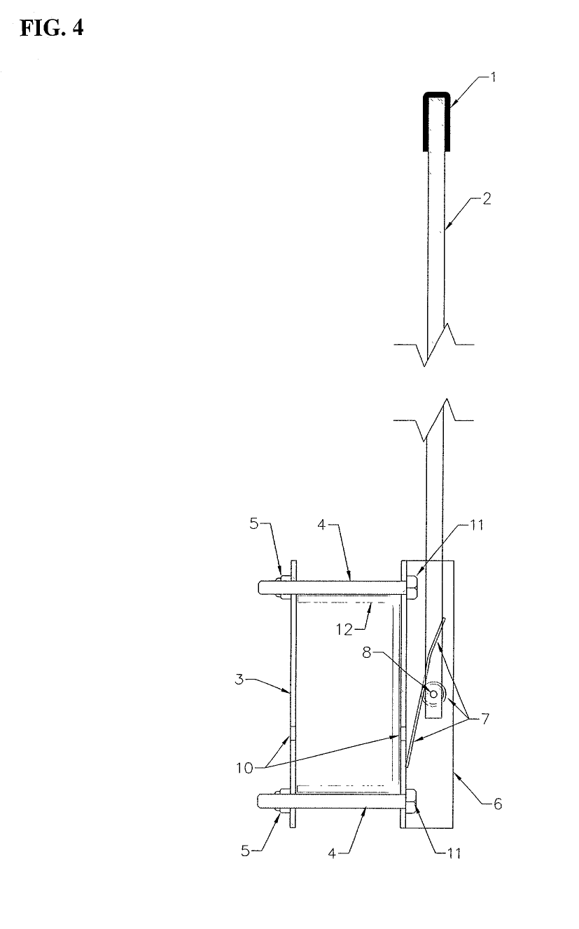

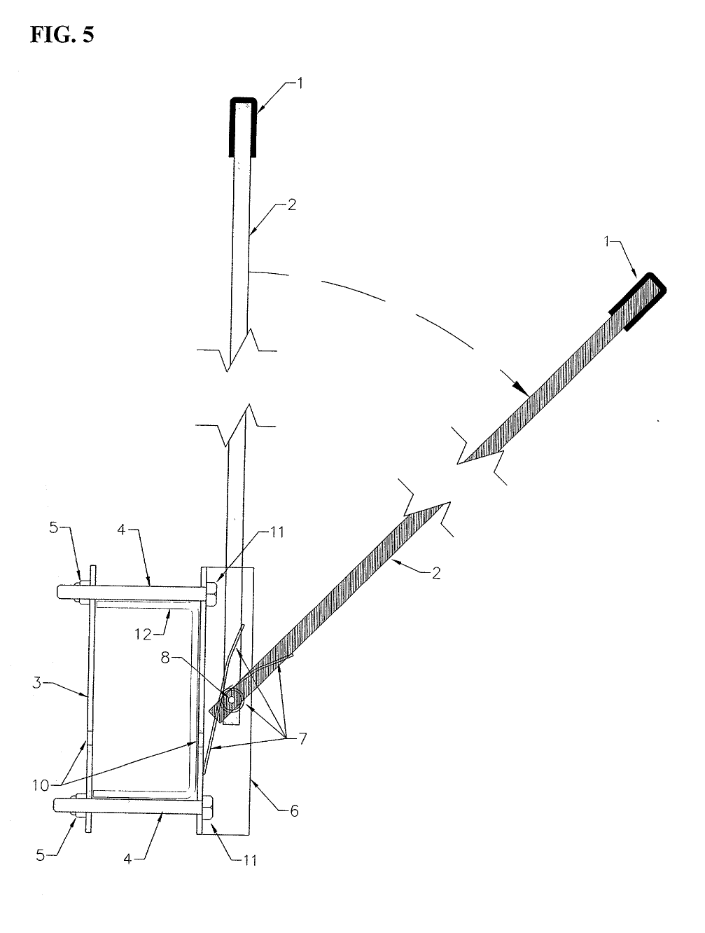

FIGS. 4-5 are a cross section illustration of how the spring 7 is attached to the front “U” channel bracket 6, incorporating the elevating rod 2. The elevating rod 2 is attached to the front “U” channel 6 with a small bolt 8 and a self-locking nut 9. The specially designed spring 7 holds tension on the elevating rod 2 to maintain its vertical position when the trailer is empty. When the trailer is loaded, tension is exerted by the elevating rod 2 on the spring 7 requiring the loaded object (boat) to keep the elevating rod 2 in a horizontal position under the boat until the boat is unloaded from the trailer. Then the spring 7 will automatically raise the elevating rod 2 back to a vertical position. There is a protective cap 1 on the tip of the elevating rod 2 to protect the loaded object (boat) from damage.

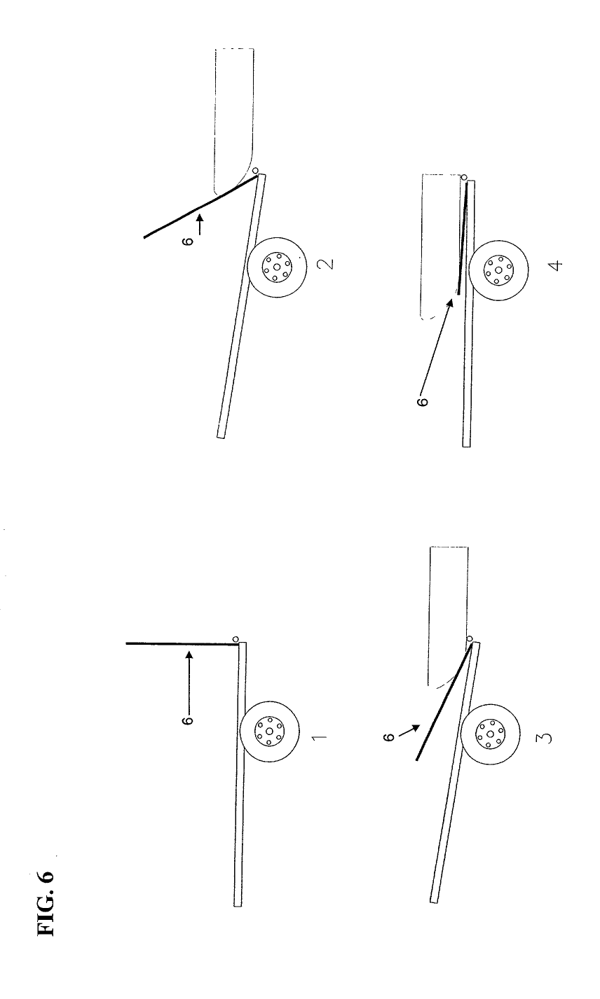

FIG. 6 illustrates in sequence how elevating rod 6 rotates from a vertical position to horizontal position as the watercraft is loaded on the trailer.

What we claim as our invention is an improved self-activating trailer backing guide as follows:

1. A new apparatus used as a backing guide for an empty trailer, visible from the driver position in a vehicle when backing said trailer:
a very simple uncomplicated attachment for a trailer with a spring loaded, elongated, fiberglass, composite rod with a rubber cap, connected to the attachment by a specially designed spring and bolt;

2. The apparatus, when attached to boat trailer, is mounted to said cross member from the front side of said cross member by self locking nuts and bolts which will pivot to a horizontal position as boat is driven or winched over the apparatus;
when boat is removed from the trailer, pivot spring will raise the rigid, fiberglass, composite rod to a vertical position, thus allowing driver to see the location of the rear of the trailer for backing purposes;
the pivot location of apparatus is located in the center point of the “U” channel bracket, attached to the rear most cross member of said trailer by two self locking nuts and bolts through a flat bar bracket, located on the rear side of said cross member.

3. This apparatus, when in a vertical position, and said trailer is backed into water, provides the driver of a boat a visual reference for driving said boat onto the center of an empty trailer.
